(19) United States
(12) Patent Application Publication
(10) Pub. No.: US 2017/0211650 A1
(43) Pub. Date: Jul. 27, 2017

(54) CYLINDER APPARATUS

(71) Applicant: HITACHI AUTOMOTIVE SYSTEMS, LTD., Hitachinaka-shi (JP)

(72) Inventors: Naoya SAKAMOTO, Yamato-shi (JP); Joel DONAHUE, Novi, MI (US)

(21) Appl. No.: 15/003,921

(22) Filed: Jan. 22, 2016

(51) Int. Cl. F16F 9/32; F16F 9/348; F16F 9/18

(52) U.S. Cl. CPC F16F 9/3257; F16F 9/187; F16F 9/348

(57) ABSTRACT

A cylinder device capable of smoothing a flow of a working fluid without increasing a size of an opening is provided. A bottom member includes a reservoir chamber side opening which can communicate with a reservoir chamber and the inner portion of an inner tube, a suction passage in which a first valve allowing the working fluid to flow from the reservoir chamber side opening into the inner tube is provided, and a discharge passage in which a second valve allowing the working fluid to flow from the inner portion of the inner tube to the reservoir chamber side opening is provided. A guide member which guides the flow of the working fluid from the reservoir chamber side opening to the suction passage and the flow of the working fluid from the discharge passage to the reservoir chamber side opening is provided between the bottom member and the closing portion.

### TECHNICAL FIELD

The invention relates to a cylinder device.

### BACKGROUND ART

There is a cylinder device in which a bottom member is provided between an inner tube and an outer tube of a bottom side (for example, refer to Patent Document 1).

### PRIOR ART DOCUMENTS

### Patent Documents

[Patent Document 1] Japanese Unexamined Patent Application, First Publication No. 2013-29133

[Patent Document 2] Japanese Unexamined Patent Application, First Publication No. 2012-207674

### DISCLOSURE OF THE INVENTION

### Problem that the Invention is to Solve

In a case where an opening which communicates with a portion between an inner tube and an outer tube and the inner portion of the inner tube is provided in a bottom member, a flow of a working fluid becomes smoother as the size of the opening increases. However, strength of the bottom member is likely to decrease as the size of the opening increases.

An object of the present invention is to provide a cylinder device capable of smoothing a flow of a working fluid.

### Means for Solving the Problem

A cylinder device of the present invention is a dual tube type cylinder device including: an inner tube in which a working fluid is sealed, and a piston provided in a rod slides in the inner portion; and an outer tube which is provided on an outer circumferential side of the inner tube and forms a reservoir chamber in which a working gas and a working fluid are sealed in a portion between the inner tube and the outer tube. The cylinder device includes a bottom member which is provided on a bottom side of the inner tube, and a closing portion which closes a bottom side of the outer tube. The bottom member includes a reservoir chamber side opening which is capable of communicating with the reservoir chamber and the inner portion of the inner tube, a suction passage in which a first valve allowing the working fluid to flow from the reservoir chamber side opening into the inner tube is provided, and a discharge passage in which a second valve allowing the working fluid to flow from the inner portion of the inner tube to the reservoir chamber side opening is provided. A guide member which guides the flow of the working fluid from the reservoir chamber side opening to the suction passage and the flow of the working fluid from the discharge passage to the reservoir chamber side opening is provided between the bottom member and the closing portion.

The second valve may be a valve which is configured as an annular disk-shaped valve which is provided on the closing portion side of the bottom member, and in which an outer circumferential side of the valve is bent toward the closing portion side so as to open the valve. The guide member may have a circular shape, and may be clamped between the bottom member and the closing portion.

The second valve may be a valve which is configured as an annular disk-shaped valve which is provided on the closing portion side of the bottom member, and in which an outer circumferential side of the valve is bent toward the closing portion side so as to open the valve. The guide member may be attached to the bottom member.

The second valve and the guide member may be coaxially disposed, a shaft member may penetrate center axes of the second valve and the guide member, and the second valve and the guide member may be attached.

The guide member may be provided to extend toward the closing portion such that an outer circumferential portion of the guide member comes into contact with the closing portion.

A through hole, which faces a position closer to an inner circumferential side of the second valve relative to the outer circumferential portion of the second valve in an axial direction, may be formed in the guide member.

The guide member may be disposed so as to face the outer circumferential portion of the second valve in the axial direction, and may regulate deformation of the second valve of a predetermined amount or more when the second valve is open.

### Effects of the Invention

According to the present invention, it is possible to smooth a flow of a working fluid.

### BRIEF DESCRIPTION OF THE DRAWINGS

FIG. 1 is a partial front view in which a bottom side of a cylinder device according to a first embodiment of the present invention is partially sectioned.

FIG. 2 is a plan view showing a guide member of the cylinder device according to the first embodiment of the present invention.

FIG. 3 is a sectional view taken along III-III of FIG. 2 showing the guide member of the cylinder device according to the first embodiment of the present invention.

FIG. 4 is a perspective view showing the guide member of the cylinder device according to the first embodiment of the present invention.

FIG. 5 is a planar sectional view showing a bottom side of a cylinder device according to a second embodiment of the present invention.

FIG. 6 is a sectional view taken along VI-VI of FIG. 5 showing the bottom side of the cylinder device according to the second embodiment of the present invention.

FIG. 7 is a plan view showing a guide member of the cylinder device according to the second embodiment of the present invention.

FIG. 8 is a sectional view taken along VIII-VIII of FIG. 7 showing the guide member of the cylinder device according to the second embodiment of the present invention.

FIG. 9 is a perspective view showing the guide member of the cylinder device according to the second embodiment of the present invention.

FIG. 10 is a partial front view in which a bottom side of a first modified example of the cylinder device according to the first embodiment of the present invention is partially sectioned.

FIG. 11 is a partial front view in which a bottom side of a second modified example of the cylinder device according to the first embodiment of the present invention is partially sectioned.

FIG. 12 is a partial front view in which a bottom side of a third modified example of the cylinder device according to the first embodiment of the present invention is partially sectioned.

### EMBODIMENTS OF THE INVENTION

### First Embodiment

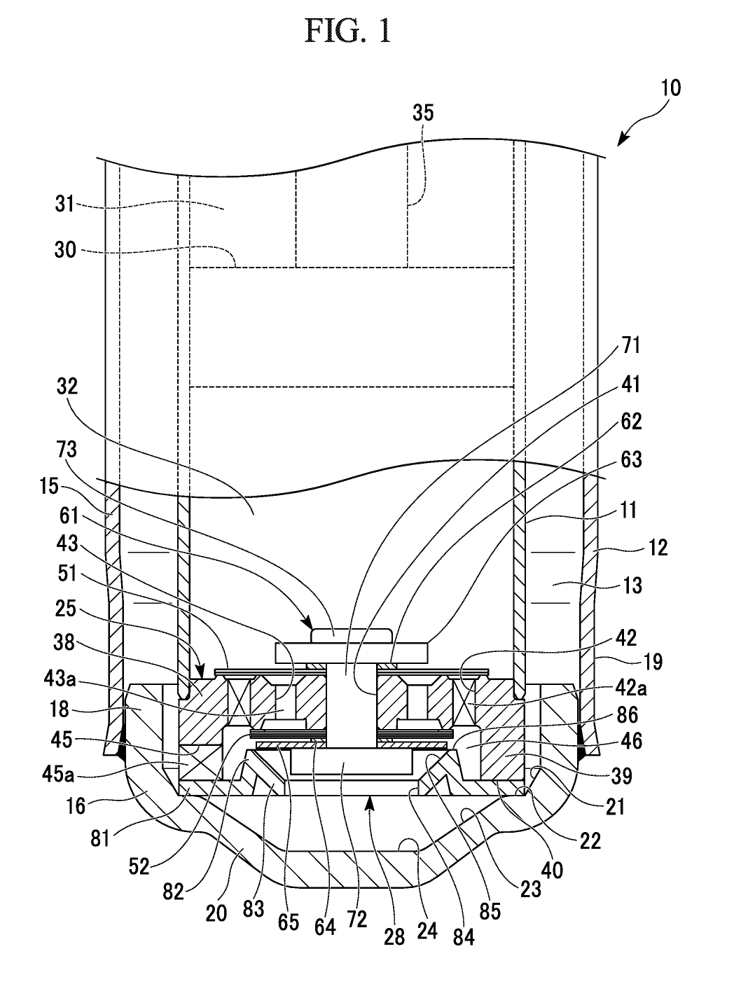

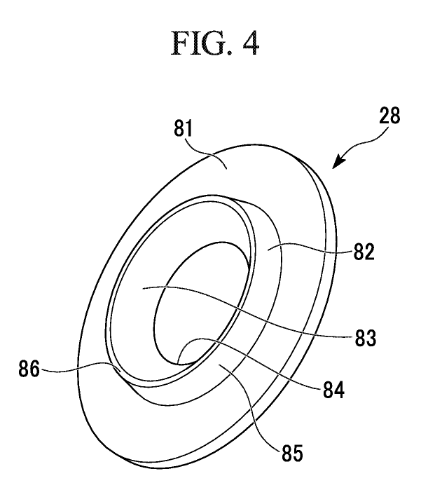

A first embodiment of the present invention will be described below with reference to FIGS. 1 to 4.

A cylinder device 10 according to the first embodiment shown in FIG. 1 is a shock absorber which is used in a suspension device of a vehicle such as an automobile or a railroad vehicle. The cylinder device 10 includes a cylindrical inner tube 11, and a bottomed outer tube 12 which has a larger diameter than that of the inner tube 11 and is provided on the outer circumferential side of the inner tube 11. A working fluid is enclosed in the inner tube 11. A reservoir chamber 13 in which gas serving as a working gas and oil serving as a working fluid are enclosed is formed between the outer tube 12 and the inner tube 11. That is, the cylinder device 10 is a dual tube type cylinder device which is configured of a dual tube structure having the inner tube 11 and the outer tube 12.

The outer tube 12 includes a metal main body member 15 and a metal closing member 16. The main body member 15 is configured of one member having a cylindrical shape. The closing member 16 is configured of one member having a bottomed cylinder shape, and is fitted to an inner side of an opening portion of one end of the main body member 15 to close the opening portion. A cylindrical tubular portion 18 of the closing member 16 which is fitted to the main body member 15, and the main body member 15 configures a cylindrical body portion 19 in the outer tube 12. A closing portion 20 of the closing member 16 which is not fitted to the main body member 15 configures the closing portion 20 which closes one end side of the outer tube 12. The closing member 16 is fixed to the main body member 15 by welding so as to be a sealed state. In the cylinder device 10, the sealed side of the outer tube 12 in an axial direction is referred to as a bottom side. In other words, the closing portion 20 closes the bottom side of the outer tube 12. The outer tube 12 is disposed so as to be coaxial with the inner tube 11, and covers the outer side of the inner tube 11 in a radial direction. In addition, the fixing between the closing member 16 and the main body member 15 is not limited to welding, but the closing member 16 and the main body member 15 may be fixed to each other by a fixing method such as swaging or welding.

The closing portion 20 includes an outer taper surface 21, an annular flat surface 22, an inner taper surface 23, and a circular flat surface 24 on the tubular portion 18 side in the axial direction from the outside in the radial direction. The outer taper surface 21 extends in the axial direction from an end edge portion of an inner circumferential surface of the tubular portion 18, and the diameter of the outer taper surface 21 decreases as the outer taper surface 21 is separated from the tubular portion 18 in the axial direction. The annular flat surface 22 extends in the inside in the radial direction from the outer taper surface 21, and expands so as to be orthogonal to the center axis of the outer tube 12. The inner taper surface 23 extends in the axial direction from an inner circumferential edge portion of the annular flat surface 22, and the diameter of the inner taper surface 23 decreases as the inner taper surface 23 is separated from the annular flat surface 22 in the axial direction. The circular flat surface 24 extends in the inside in the radial direction from the inner taper surface 23, and is orthogonal to the center axis of the outer tube 12.

The inner tube 11 is configured of one metal member having a cylindrical shape. A circular bottom member 25 is attached to one end portion in the axial direction of the inner tube 11. The bottom member 25 is circular, and is attached to the end portion on the bottom side of the inner tube 11. The bottom member 25 is fitted to the inner tube 11 so as to be fixed to the inner tube 11. A plate-shaped guide member 28 is disposed on the side opposite to the inner tube 11 with respect to the bottom member 25. The bottom member 25 which is fixed to one end portion in the axial direction of the inner tube 11 is placed on the guide member 28, and the guide member 28 is placed on the closing portion 20 of the outer tube 12. In other words, the guide member 28 is disposed between the bottom member 25 and the closing portion 20 of the outer tube 12.

Although it is not shown in the drawings, the end portion opposite to the bottom member 25 in the axial direction of the inner tube 11 is fitted to a rod guide so as to be fixed to the rod guide. The rod guide is fitted to the inner side of the body portion 19 of the outer tube 12. A seal member (not shown) is provided on the side opposite to the closing portion 20 with respect to the rod guide. The seal member is also fitted to the inner side of the body portion 19. The side opposite to the closing portion 20 of the seal member is locked to the outer tube 12. Accordingly, the seal member, the rod guide, the inner tube 11, the bottom member 25, and the guide member 28 are clamped between one end side and the other end side in the axial direction of the outer tube 12. Therefore, the guide member 28 is clamped between the bottom member 25 and the closing portion 20.

A piston 30 is slidably fitted into the inner tube 11. In other words, the piston 30 slides inside the inner tube 11. In the inner portion of the inner tube 11, a portion between the piston 30 and the above-described rod guide becomes a first chamber 31, and a portion between the piston 30 and the bottom member 25 becomes a second chamber 32. In other words, the first chamber 31 is provided on the side opposite to the closing portion 20 from the piston 30 in the inner tube 11, and the second chamber 32 is provided on the closing portion 20 side from the piston 30 in the inner tube 11. The second chamber 32 in the inner tube 11 is defined as a reservoir chamber 13 by the bottom member 25 which is provided on one end side of the inner tube 11.

A rod 35 is connected to the piston 30. The rod 35 is inserted into the inner tube 11 through the above-described seal member and rod guide, and a tip end of the inserted side is connected to the piston 30. The piston 30 provided in the rod 35 integrally move with the rod 35. The rod 35 extends to the outside from the inner tube 11 and the outer tube 12 through the above-described rod guide and seal member.

Although it is not shown, an extension side damping force generation mechanism is provided in the piston 30, which allows the working fluid to flow from the first chamber 31 to the second chamber 32 and suppresses the flow so as to generate a damping force when the rod 35 moves toward an extension side in which an extension amount of the rod 35 from the inner tube 11 and the outer tube 12 increases. A compression side damping force generation mechanism is provided in the piston 30, which allows the working fluid to flow from the second chamber 32 to the first chamber 31 and suppresses the flow so as to generate a damping force when the rod 35 moves toward a compression side in which the extension amount of the rod 35 from the inner tube 11 and the outer tube 12 decreases. In the cylinder device 10, for example, the rod 35 is connected to a vehicle body side of a vehicle, the closing portion 20 side is connected to a wheel side of the vehicle, and the cylinder device 10 generates a damping force according to a movement of the wheel with respect to the vehicle body.

The bottom member 25 includes a circular base plate portion 38 and a tubular foot portion 39. The foot portion 39 protrudes toward the side opposite to the inner tube 11 in the axial direction from the outer circumferential side of the base plate portion 38. An end surface 40 of the foot portion 39 on the side opposite to the base plate portion 38 in the axial direction extends in the direction orthogonal to the center axis of the bottom member 25. A through hole 41 penetrating the base plate portion 38 in the axial direction is formed on the center portion in the radial direction of the base plate portion 38. A passage hole 42 and a passage hole 43 penetrating the base plate portion 38 in the axial direction are formed between the through hole 41 and the foot portion 39 on the base plate portion 38. The passage hole 43 is disposed between the through hole 41 and the passage hole 42 in the radial direction of the base plate portion 38.

A passage groove 45 is formed in the bottom member 25. The passage groove 45 is formed on the side opposite to the base plate portion 38 of the foot portion 39, and penetrates the foot portion 39 in the radial direction. A reservoir chamber side opening 45a is formed inside the passage groove 45, which always allows a chamber 46 in the inside in the radial direction of the foot portion 39 to communicate with the reservoir chamber 13. A passage 42a (suction passage) is formed inside the passage hole 42, which can allow the chamber 46 inside the foot portion 39 to communicate with the second chamber 32. A passage 43a (discharge passage) is formed inside the passage hole 43, which can allow the chamber 46 inside the foot portion 39 to communicate with the second chamber 32. The passages 42a and 43a provided in the bottom member 25 can allow the second chamber 32 and the reservoir chamber 13 to communicate with each other via the reservoir chamber side opening 45a. Accordingly, the reservoir chamber side opening 45a which is provided in the bottom member 25 can allow the reservoir chamber 13 and the second chamber 32 inside the inner tube 11 to communicate with each other via the passages 42a and 43a.

In the bottom member 25, a first valve 51 is provided on the side opposite to the foot portion 39 in the axial direction of the base plate portion 38. In the bottom member 25, a second valve 52 is provided on the foot portion 39 side in the axial direction of the base plate portion 38. The first valve 51 is a disk valve which is configured of a plurality of disks. The second valve 52 also is a disk valve which is configured of a plurality of disks. Both of the first valve 51 and the second valve 52 are circular, and are attached to the bottom member 25 by a rivet 61 along with a ring 62, a ring 63 having a larger diameter than that of the ring 62, a ring 64, and a ring 65 having a larger diameter than that of the ring 64.

The rivet 61 serving as a shaft member includes a shaft portion 71 and a flange portion 72 which has a larger diameter than that of the shaft portion 71. In the rivet 61, the shaft portion 71 is inserted into the inner sides of the ring 65, the ring 64, the second valve 52, the bottom member 25, the first valve 51, the ring 62, and the ring 63 in this order. In this state, the rivet 61 is swaged such that the portion of the shaft portion 71 positioned further outside in the axial direction relative to the ring 63 expands to a radially outward direction. A swaged portion 73 of the rivet 61 formed by the swaging and the flange portion 72 clamps the ring 63, the ring 62, the first valve 51, the bottom member 25, the second valve 52, the ring 64, and the ring 65 between both sides in the axial direction. The second valve 52 is configured as an annular disk-shaped valve which is provided on the closing portion 20 side of the bottom member 25, and the valve is opened when the outer circumferential side of the valve is bent to the closing portion 20 side.

The first valve 51 is disposed on the side opposite to the closing portion 20 of the bottom member 25, and the passage 42a is closed when the first valve 51 comes into contact with the bottom member 25. The first valve 51 has a larger diameter than that of the ring 62, and if the portion of the first valve 51 outside the ring 62 is deformed in a direction separated from the bottom member 25 and is separated from the bottom member 25, the passage 42a is open. The first valve 51 is provided on the passage 42a so as to open and close the passage 42a. An opening (not shown) through which the passage 43a and the second chamber 32 always communicate with each other is provided in the first valve 51. The ring 63 having a larger diameter than that of the ring 62 regulates deformation of a predetermined amount or more of the first valve 51.

The first valve 51 is a check valve which allows the flow of the working fluid from the reservoir chamber side opening 45a to the second chamber 32 side via the passage 42a, and regulates the flow of the working fluid from the second chamber 32 to the reservoir chamber side opening 45a side via the passage 42a. Accordingly, the first valve 51 allows the flow of the working fluid from the reservoir chamber 13 to the second chamber 32 side via the reservoir chamber side opening 45a and the passage 42a, and regulates the flow of the working fluid from the second chamber 32 to the reservoir chamber 13 side via the passage 42a and the reservoir chamber side opening 45a.

The first valve 51 is a suction valve which allows the working fluid to flow from the reservoir chamber 13 into the second chamber 32 without substantially generating a damping force when the first valve 51 allows the flow of the working fluid from the reservoir chamber 13 to the second chamber 32 side via the reservoir chamber side opening 45a and the passage 42a. If the rod 35 moves toward the extension side in which the extension amount from the inner tube 11 increases, the piston 30 moves toward the first chamber 31 side, and the pressure of the second chamber 32 decreases so as to be lower than the pressure of the reservoir chamber 13, the first valve 51 opens the passages 42a.

The second valve 52 is disposed on the closing portion 20 side of the bottom member 25. The second valve 52 has a larger diameter than that of the ring 64, and the passage 43a is closed when the second valve 52 comes into contact with the bottom member 25. If the portion of the second valve 52 outside the ring 64 is deformed in a direction separated from the bottom member 25 and is separated from the bottom member 25, the passage 43a is open. The second valve 52 is provided on the passage 43a so as to open and close the passage 43a.

The second valve 52 is a check valve which allows the flow of the working fluid from the second chamber 32 to the reservoir chamber side opening 45a side via an opening (not shown) formed in the first valve 51 and the passage 43a, and regulates the flow of the working fluid from the reservoir chamber side opening 45a side to the second chamber 32 side via the passage 43a. Accordingly, the second valve 52 allows the flow of the working fluid from the second chamber 32 side to the reservoir chamber 13 side via the passage 43a and the reservoir chamber side opening 45a, and regulates the flow of the working fluid from the reservoir chamber 13 to the second chamber 32 side via the reservoir chamber side opening 45a and the passage 43a. The ring 65 having a larger diameter than that of the ring 64 regulates deformation of a predetermined amount or more of the second valve 52.

The second valve 52 is a damping valve which controls the flow of the working fluid to generate a damping force when the second valve 52 allows the flow of working fluid from the second chamber 32 to the reservoir chamber 13 side via the passage 43a and the reservoir chamber side opening 45a. If the rod 35 moves toward the compression side in which an entering amount of the rod 35 into the inner tube 11 increases, the piston 30 moves toward the second chamber 32 side, and the pressure of the second chamber 32 is higher by a predetermined value or more than pressure of the reservoir chamber 13, the second valve 52 opens the passage 43a.

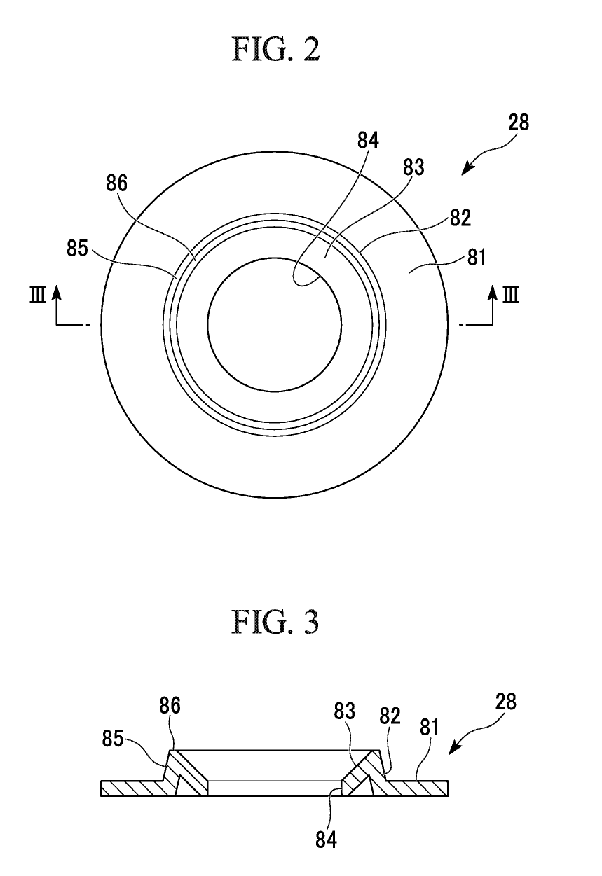

As shown in FIGS. 2 to 4, the guide member 28 is annular. In order words, the guide member 28 is circular. In the guide member 28, an outer flat plate portion 81, an outer taper plate portion 82, and an inner taper plate portion 83 are provided in this order from the outer circumferential side of the guide member.

The outer flat plate portion 81 has a flat plate shape, and has an annular shape in which the center axis extends in the thickness direction. In the outer flat plate portion 81, a width in the radial direction over the entire circumference is constant.

The outer taper plate portion 82 extends from the inner circumferential edge portion of the outer flat plate portion 81 to one side in the thickness direction of the outer flat plate portion 81. The outer taper plate portion 82 has a tubular shape, and the diameter of the outer taper plate portion 82 decreases as the outer taper plate portion 82 is separated from the outer flat plate portion 81.

The inner taper plate portion 83 extends in a direction opposite to the extension direction of the outer taper plate portion 82 with respect to the outer flat plate portion 81 from the end edge portion of the side of the outer taper plate portion 82 opposite to the outer flat plate portion 81. The inner taper plate portion 83 has an annular shape, and the diameter of the inner taper plate portion 83 decreases as the inner taper plate portion 83 is separated from the outer taper plate portion 82. A through hole 84 penetrating the guide member 28 in the axial direction in the center of the guide member 28 is formed in the inside in the radial direction of the inner taper plate portion 83.

The outer taper plate portion 82 and the inner taper plate portion 83 configure an annular protrusion portion 85 which protrude from the outer flat plate portion 81 to the one side in the axial direction. The guide member 28 is formed in the above-described shape by press-forming one plate member having a constant thickness.

As shown in FIG. 1, in the guide member 28, in a state where the annular protrusion portion 85 protrudes from the outer flat plate portion 81 toward the base plate portion 38, the outer flat plate portion 81 is clamped between the bottom member 25 and the closing portion 20. At this time, in the guide member 28, the outer flat plate portion 81 is placed on the annular flat surface 22 of the closing portion 20 and is disposed inside the outer taper surface 21, and the movement of the guide member 28 in the radial direction is regulated by the outer taper surface 21. Moreover, at this time, the outer flat plate portion 81 comes into surface contact with the annular flat surface 22 of the closing portion 20 and also comes into surface contact with the end surface 40 of the foot portion 39.

A portion which is surrounded by the outer flat plate portion 81 and the passage groove 45 of the bottom member 25 becomes a reservoir chamber side opening 45a. The outer flat plate portion 81 is not positioned in a direction further separated from the base plate portion 38 relative to the reservoir chamber side opening 45a in the axial direction of the bottom member 25. The outer taper plate portion 82 protrudes from the outer flat plate portion 81 toward the base plate portion 38.

The position of the outer taper plate portion 82 overlaps the position of the reservoir chamber side opening 45a in the axial direction of the bottom member 25 on the extension of the reservoir chamber side opening 45a in the radial direction of the bottom member 25. The outer taper plate portion 82 is inclined so as to approach the passage 42a and the passage 43a in the axial direction of the bottom member 25 as the outer taper plate portion 82 is separated from the reservoir chamber side opening 45a in the radial direction of the bottom member 25.

An apex portion 86 on the protruding tip end side of the annular protrusion portion 85 is disposed between the center of the passage hole 42 and the center of the passage hole 43. The apex portion 86 is disposed so as to closer to the passage hole 42 than the passage hole 43 in the radial direction. The apex portion 86 has an outer diameter which is larger than the outer diameter of the second valve 52.

The positions of the outer flat plate portion 81 and the outer taper plate portion 82 overlap the positions in the radial direction of the passage hole 42 and the bottom member 25 on the extension of the passage hole 42 in the axial direction of the bottom member 25. The outer taper plate portion 82 has a larger diameter as it is separated from the passage 42a in the axial direction of the bottom member 25, and is inclined so as to approach the reservoir chamber side opening 45a in the radial direction of the bottom member 25. The outer flat plate portion 81 extends toward the reservoir chamber side opening 45a from the end edge portion of the outer taper plate portion 82 of the side opposite to the passage 42a.

In the guide member 28, the outer flat plate portion 81 and the outer taper plate portion 82 guide the flow of the working fluid from the reservoir chamber side opening 45a to the passage 42a in the direction approaching the passage 42a. In other words, the outer flat plate portion 81 and the outer taper plate portion 82 prevent the working fluid from the reservoir chamber side opening 45a to the passage 42a from flowing in the direction separated from the passage 42a. In addition, in other words, the outer flat plate portion 81 and the outer taper plate portion 82 guide the flow of the working fluid such that a distance in which the working fluid flows from the reservoir chamber side opening 45a to the passage 42a approaches the shortest distance.

In the guide member 28, the outer taper plate portion 82 and the outer flat plate portion 81 open the second valve 52 from the passage 43a, and guide the flow of the working fluid toward the reservoir chamber side opening 45a guided toward the outside in the radial direction by the second valve 52 in the direction approaching the reservoir chamber side opening 45a. In other words, the outer flat plate portion 81 and the outer taper plate portion 82 open the second valve 52 from the passage 43a, and prevent the flow of the working fluid guided toward the outside in the radial direction by the second valve 52 from being directed in the direction separated from the reservoir chamber side opening 45a. In addition, in other words, the outer flat plate portion 81 and the outer taper plate portion 82 guides the flow of the working fluid such that the distance in which the working fluid flows from the passage 43a to the reservoir chamber side opening 45a approaches the shortest distance.

In the cylinder device 10, when the rod 35 moves toward the extension side, the piston 30 moves toward the first chamber 31 side, and the pressure of the first chamber 31 is higher by a predetermined value or more than the pressure of the second chamber 32, the extension side damping force generation mechanism provided in the piston 30 allows the working fluid of the first chamber 31 to flow toward the second chamber 32. At this time, the extension side damping force generation mechanism controls the flow of the working fluid to generate a damping force.

At this time, a volume in the inner tube 11 increases as the rod 35 protrudes from the inner tube 11, the first valve 51 is separated from the bottom member 25 to open the passage 42a, and the working fluid is supplied from the reservoir chamber 13 to the second chamber 32 by the opening of the passage 42a. At this time, the first valve 51 is open without substantially interfering with the flow of the working fluid to smoothly supply the working fluid from the reservoir chamber 13 to the second chamber 32.

In addition, in the cylinder device 10, when the rod 35 moves toward the compression side, the piston 30 moves toward the second chamber 32 side, and the pressure of the second chamber 32 is higher by a predetermined value or more than the pressure of the first chamber 31, the compression side damping force generation mechanism provided in the piston 30 allows the working fluid of the second chamber 32 to flow toward the first chamber 31. At this time, the compression side damping force generation mechanism regulates the flow of the working fluid to generate a damping force.

At this time, a volume in the inner tube 11 decreases as the rod 35 enters the inner tube 11, the second valve 52 is separated from the bottom member 25 to open the passage 43a, and the working fluid is discharged from the second chamber 32 to the reservoir chamber 13 by the opening of the passage 43a. At this time, the second valve 52 regulates the flow of the working fluid to generate the damping force.

The above-described Patent Document 1 discloses a cylinder device in which a bottom member is provided between an inner tube and an outer tube of a bottom side. In the bottom member, an opening is provided, through which a reservoir chamber between the inner tube and the outer tube and the inner portion of the inner tube communicate with each other. A pressure loss decreases as the size of the opening increases, and the flow of the working fluid becomes smooth. However, strength of the bottom member is likely to decrease. Accordingly, it is not possible to sufficiently increase the opening, and the working fluid is not likely to smoothly flow between the reservoir chamber and the inner portion of the inner tube. Moreover, for example, if a countermeasure such as increasing the thickness of the foot portion 39 is performed so as to prevent the decrease in the strength of the bottom member, the length in the axial direction and the length in the radial direction increase, the size and the weight increase, and there is a problem that performance decreases due to a decrease in the volume of the reservoir chamber 13.

Meanwhile, in the cylinder device 10 of the first embodiment, the plate-shaped guide member 28 which is provided between the bottom member 25 and the closing portion 20 of the outer tube 12 guides the flow of the working fluid from the reservoir chamber side opening 45a provided in the bottom member 25 to the passage 42a in which the first valve 51 is provided, and the flow of the working fluid from the passage 43a in which the second valve 52 is provided to the reservoir chamber side opening 45a. Accordingly, even when the size of the reservoir chamber side opening 45a provided in the bottom member 25 does not increase, it is possible to smooth the flow of the working fluid from the reservoir chamber side opening 45a to the passage 42a, and the flow of the working fluid from the passage 43a to the reservoir chamber side opening 45a. Therefore, it is possible to prevent the pressure loss caused by the flow of the working fluid, and it is possible to improve responsibility.

Moreover, in the above-described Patent Document 2, an annular protrusion portion is shown in a closing portion. However, since the closing portion is press-formed, it is not easy to form the protrusion portion. In addition, it is not possible to form the cylinder device 10 by closing. In addition, the protrusion portion is formed so as to come into contact with the foot portion 39 of the bottom portion 25. That is, a technical concept of the protrusion portion being formed to smooth the flow of the working fluid and to decrease the pressure loss is not disclosed.

In the cylinder device 10 of the first embodiment, since the guide member 28 separated from the bottom member 25 is provided, it is possible to smooth the flow of the working fluid without changing the shape of the bottom member 25.

In the cylinder device 10 of the first embodiment, since the guide member 28 is clamped between the bottom member 25 and the closing portion 20 of the outer tube 12, the attachment structure of the guide member 28 is simple. Accordingly, it is possible to prevent an increase in a cost.

### Second Embodiment

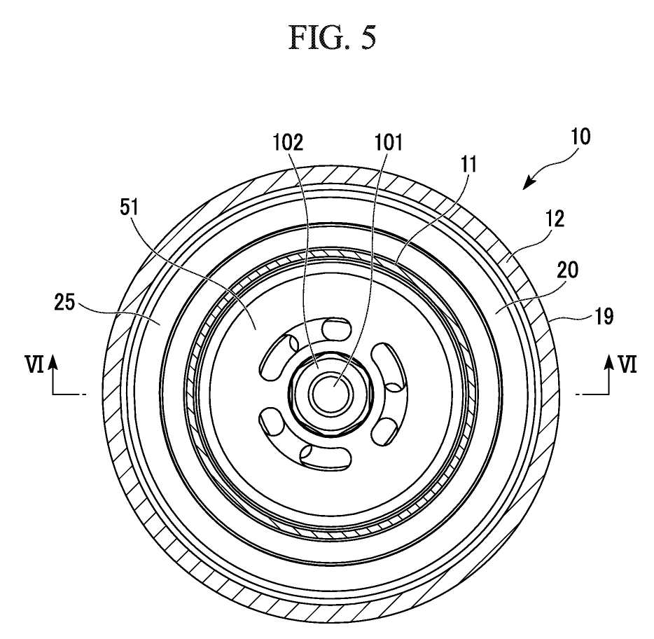

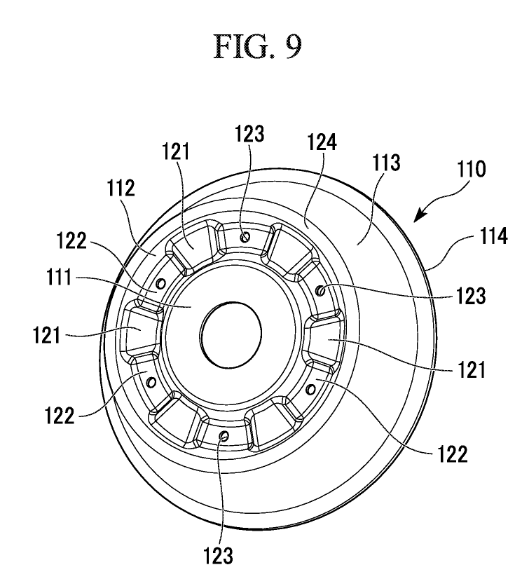

Next, with respect to a second embodiment, portions different from the first embodiment will be mainly described with reference to FIGS. 5 to 9. In addition, the same designations and the same reference numerals are assigned to the portions common to the first embodiment.

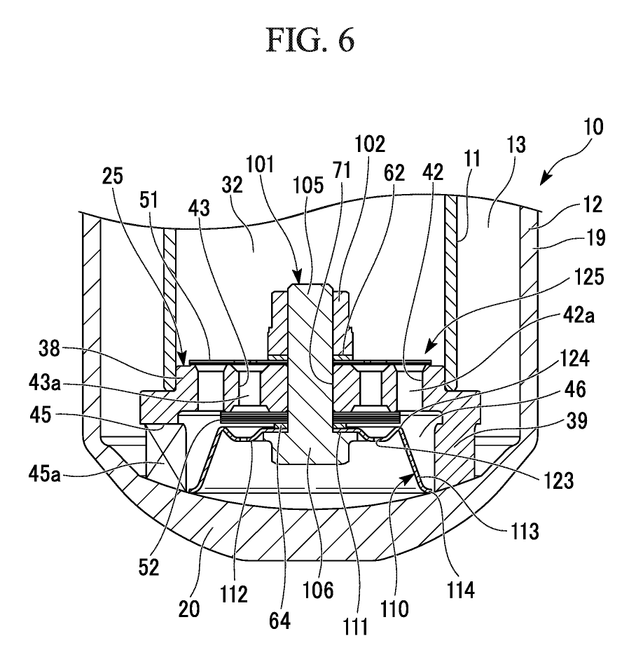

In the second embodiment, the outer tube 12 shown in FIGS. 5 and 6 is partially different from that of the first embodiment. In the outer tube 12 of the second embedment, for example, as shown in FIG. 6, the cylindrical body portion 19 and the closing portion 20 which seals one end of the body portion 19 are integrally molded by a processing method such as closing. In addition, in the second embodiment, the foot portion 39 of the bottom member 25 comes into contact with the closing portion 20. Moreover, in the second embodiment, instead of the rivet 61 of the first embodiment, a bolt 101 and a nut 102 are provided. In addition, in the second embodiment, a guide member 110 is attached to the bottom member 25 along with the first valve 51 and the second valve 52 by the bolt 101 and the nut 102. The bolt 101 includes a screw shaft portion 105 which is screwed to the nut 102, and a head portion 106 having a larger diameter than that of the screw shaft portion 105.

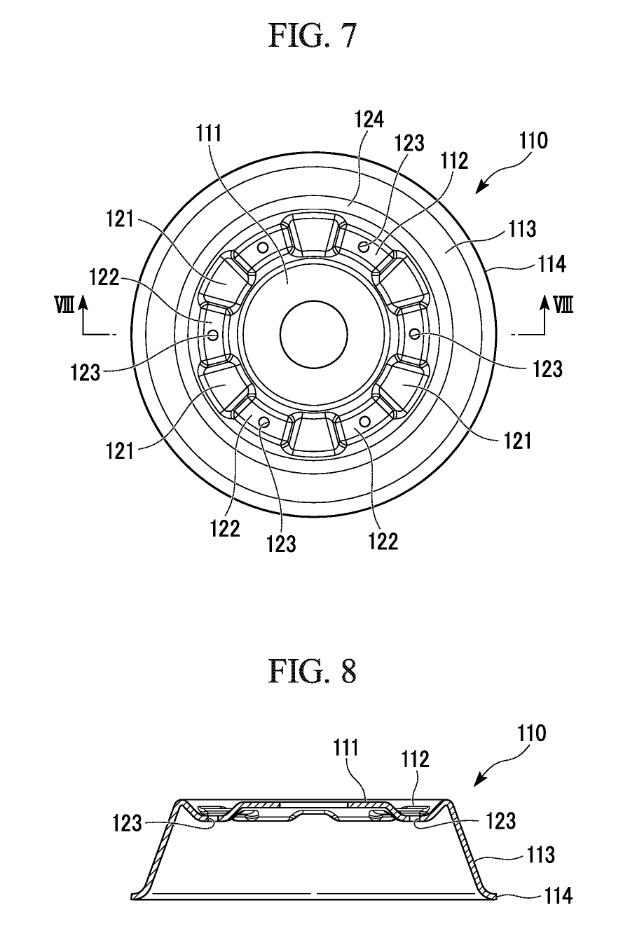

As shown in FIGS. 7 to 9, the guide member 110 is annular. In the guide member 110, an inner flat plate portion 111, an intermediate plate portion 112, a taper plate portion 113, and a flange plate portion 114 are provided in this order from the center side of the guide member 110.

The inner flat plate portion 111 has a flat plate shape, and has an annular shape in which the center axis extends in the thickness direction. In the inner flat plate portion 111, a width in the radial direction over the entire circumference is constant.

The intermediate plate portion 112 extends from the outer circumferential end edge of the inner flat plate portion 111 to the outside in the radial direction. The entire shape of the intermediate plate portion 112 has an annular shape in which the center axis extends in the thickness direction. In the intermediate plate portion 112, the width in the radial direction over the entire circumference is constant. In the intermediate plate portion 112, concave portions 121 recessed to one end in the plate thickness direction and convex portions 122 protruding toward the opposite side in the plate thickness direction are alternately formed in the circumferential direction. Accordingly, the concave portions 121 and the convex portions 122 form a rib, and stiffness of the intermediate plate portion 112 increases. In addition, a through hole 123 penetrating in the plate thickness direction is formed in each of the convex portions 122. The through holes 123 are provided in the convex portions 122, and the plurality of through holes 123 are formed in the circumferential direction with intervals therebetween. In addition, it is not necessary to form the through holes 123 in all convex portions 122, and only one through 123 may be provided. In addition, the through hole 123 is disposed so as to face the position of the circumference side inside the outer circumferential portion of the second valve 52 in the axial direction. In order words, the through hole 123 is disposed on the convex portion 122 of the intermediate plate portion 112 which is positioned inside the annular protrusion portion 124 of the guide member 110 positioned so as to face the outer circumferential portion of the second valve 52 in the axial direction. Accordingly, since the through holes 123 is provided at the position except for a region in which the flow of the working fluid from the reservoir chamber side opening 45a to the passage 42a is generated and a region in which the flow of the working fluid from the passage 43a to the reservoir chamber side opening 45a is generated, the flow generation in a region except for the flow existing regions is prevented, and it is possible to smooth the flow of the working fluid.

The taper plate portion 113 extends in the recessed direction of the concave portion 121 from the outer circumferential edge portion of the intermediate plate portion 112. The taper plate portion 113 is tubular, and the diameter of the taper plate portion 113 increases as it is separated from the intermediate plate portion 112. The flange plate portion 114 extends to the outside in the radial direction from the end edge portion of the side opposite to the intermediate plate portion 112 of the taper plate portion 113. The flange plate portion 114 is formed in an annular shape having a constant width in the radial direction. The guide member 110 is also formed in the above-described shape by press-forming one plate member having a constant thickness. Moreover, the flange plate portion 114 is provided so as to extend toward the closing portion 20.

As shown in FIG. 6, the inner flat plate portion 111 of the guide member 110, the ring 64, the second valve 52, the bottom member 25, the first valve 51, and the ring 62 are put on the head portion 106 of the bolt 101 in stack in this order while the screw shaft portion 105 of the bolt 101 passes through the inner sides of the above-described components. At this time, the guide member 110 is put in a posture where the taper plate portion 113 extends from the inner flat plate portion 111 to the head portion 106 side, the foot portion 39 of the bottom member 25 extends from the base plate portion 38 to the head portion 106 side of the bolt 101. In this state, the nut 102 is screwed to the screw shaft portion 105 of the bolt 101, and the inner flat plate portion 111 of the guide member 110, the ring 64, the second valve 52, the bottom member 25, the first valve 51, and the ring 62 are clamped between the head portion 106 and the nut 102. Accordingly, an assembly 125 is completed in which the guide member 110 is attached to the bottom member 25 along with the first valve 51 and the second valve 52. The assembly 125 is placed on the closing portion 20 of the outer tube 12 in the foot portion 39 of the bottom member 25. A portion which is surrounded by the closing portion 20 and the passage groove 45 of the bottom member 25 becomes the reservoir chamber side opening 45a. In this way, the second valve 52 and the guide member 110 are coaxially disposed, the screw shaft portion 105 serving as the shaft member penetrates the center axis, and the second valve 52 and the guide member 110 are integrally attached to the bottom member 25.

At this time, in the guide member 110, the flange plate portion 114 protrudes from the intermediate plate portion 112 toward the closing portion 20 and comes into contact with the closing portion 20. The position of the taper plate portion 113 overlaps the position of the reservoir chamber side opening 45a in the axial direction of the bottom member 25 on the extension of the reservoir chamber side opening 45a in the radial direction of the bottom member 25. The taper plate portion 113 is inclined so as to approach the passage 42a and the passage 43a in the axial direction of the bottom member 25 as the taper plate portion 113 is separated from the reservoir chamber side opening 45a in the radial direction of the bottom member 25.

A boundary portion between the taper plate portion 113 and the intermediate plate portion 112 becomes the annular protrusion portion 124 which has an annular shape and protrudes in the direction opposite to the flange plate portion 114. The annular protrusion portion 124 is disposed between the center of the passage hole 42 and the center of the passage hole 43. The annular protrusion portion 124 is disposed so as to closer to the passage hole 42 than the passage hole 43 in the radial direction. The annular protrusion portion 124 has a diameter which is approximately the same as the outer diameter of the second valve 52.

The position of the taper plate portion 113 overlap the positions in the radial direction of the passage hole 42 and the bottom member 25 on the extension of the passage hole 42 in the axial direction of the bottom member 25. The taper plate portion 113 has a larger diameter as it is separated from the passage 42a in the axial direction of the bottom member 25, and is inclined so as to approach the reservoir chamber side opening 45a in the radial direction of the bottom member 25.

The annular protrusion portion 124 of the guide member 110 is disposed so as to face the outer circumferential portion of the second valve 52 in the axial direction, and regulates deformation of a predetermined amount or more of the second valve 52 when the second valve 52 is open. The through hole 123 of the convex portion 122 is an air vent hole for preventing variations in quality due to occurrence of stagnant air during assembly. The through hole may be provided in the taper plate portion. However, since a flow other than the flow of the fluid from the reservoir chamber 13 to the reservoir chamber side opening 45a is likely to occur when the rod 35 moves toward the extension side in which the extension amount increases from the inner tube 11 and the outer tube 12, that is, during the extension stroke, preferably, the through hole is provided in the convex portion 122 which is less affected by the flow. Accordingly, it is possible to smooth the flow of the working fluid.

In the guide member 110, the taper plate portion 113 and the flange plate portion 114 guide the flow of the working fluid from the reservoir chamber side opening 45a to the passage 42a in the direction approaching the passage 42a. In other words, the taper plate portion 113 and the flange plate portion 114 prevent the working fluid from the reservoir chamber side opening 45a to the passage 42a from flowing in the direction separated from the passage 42a. In addition, in other words, the taper plate portion 113 and the flange plate portion 114 guide the flow of the working fluid such that a distance in which the working fluid flows from the reservoir chamber side opening 45a to the passage 42a approaches the shortest distance.

In the guide member 110, the taper plate portion 113 and the flange plate portion 114 open the second valve 52 from the passage 43a, and guide the flow of the working fluid toward the reservoir chamber side opening 45a guided toward the outside in the radial direction by the second valve 52 in the direction approaching the reservoir chamber side opening 45a. In other words, the taper plate portion 113 and the flange plate portion 114 open the second valve 52 from the passage 43a, and prevent the flow of the working fluid guided toward the outside in the radial direction by the second valve 52 from being directed in the direction separated from the reservoir chamber side opening 45a. In addition, in other words, the taper plate portion 113 and the flange plate portion 114 guides the flow of the working fluid such that the distance in which the working fluid flows from the passage 43a to the reservoir chamber side opening 45a approaches the shortest distance.

In the cylinder device 10 of the second embodiment, the plate-shaped guide member 110 which is provided between the bottom member 25 and the closing portion 20 of the outer tube 12 guides the flow of the working fluid from the reservoir chamber side opening 45a provided in the bottom member 25 to the passage 42a in which the first valve 51 is provided, and the flow of the working fluid from the passage 43a in which the second valve 52 is provided to the reservoir chamber side opening 45a. Accordingly, even when the size of the reservoir chamber side opening 45a provided in the bottom member 25 does not increase, it is possible to smooth the flow of the working fluid from the reservoir chamber side opening 45a to the passage 42a, and the flow of the working fluid from the passage 43a to the reservoir chamber side opening 45a. Therefore, it is possible to prevent the pressure loss caused by the flow of the working fluid, and it is possible to improve responsibility.

In the cylinder device 10 of the second embodiment, since the guide member 110 separated from the bottom member 25 is provided, it is possible to smooth the flow of the working fluid without changing the shape of the bottom member 25.

In the cylinder device 10 of the second embodiment, since the guide member 110 is integrally attached to the bottom member 25, it is possible to dispose the guide member 110 in the outer tube 12 along with the bottom member 25. Accordingly, disposition of the guide member 110 in the outer tube 12 is easy. Therefore, an assembly operation of the cylinder device 10 is easy.

Here, in the guide member 110, the flange plate portion 114 comes into contact with the closing portion 20. However, the flange plate portion 114 may be slightly separated from the closing portion 20. However, if the separation distance between the flange plate portion 114 and the closing portion 20 increases, since the gap therebetween increases and the taper plate portion 113 is shortened in the axial direction, performance of guiding the flow of the working fluid deteriorates. Accordingly, preferably, the length in the axial direction of the taper plate portion 113 increases until the flange plate portion 114 comes into contact with the closing portion 20.

In addition, the cases are described in which the guide members 28 and 110 of the first and second embodiments are molded in the shapes of the first and second embodiments by press-forming one plate-shaped member having a constant thickness. However, the present invention is not limited to the press-forming, the guide members may be formed by forming methods such as deep drawing or forging, and in this case, the guide members may be not formed of a plate-shaped member.

### First Modified Example of First Embodiment

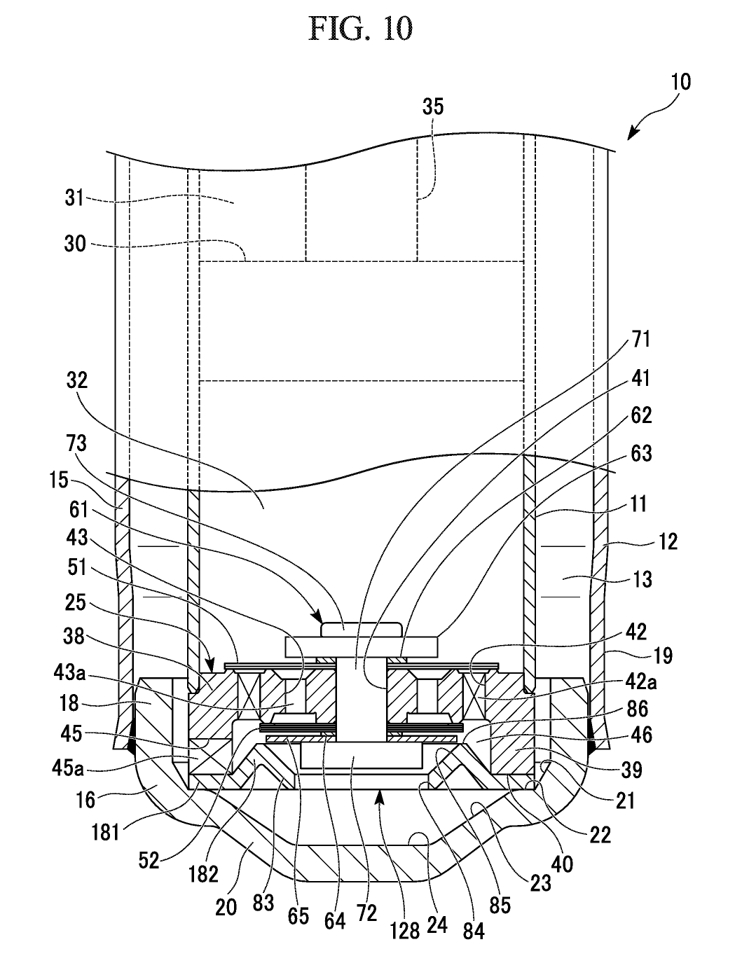

Next, with respect to a first modified example of the first embodiment, portions different from the first embodiment will be mainly described with reference to FIG. 10. In addition, the same designations and the same reference numerals are assigned to the portions common to the first embodiment.

In the first modified example of the first embodiment, a guide member 128 shown in FIG. 10 is partially different from the guide member 28 of the first embodiment. In the guide member 128 of the first modified example, an angle of an outer taper plate portion 182 with respect to an outer flat plate portion 181 is changed such that the width in the radial direction of the outer flat plate portion 181 is the same as the width in the radial direction of the foot portion 39 of the bottom member 125. According to this configuration, it is possible to hold the inner circumferential side of the foot portion 39 of the bottom member 25 by the outer taper plate portion 182 of the guide member 128, and it is possible to improve assembly accuracy by performing positioning in the radial direction.

### Second Modified Example of First Embodiment

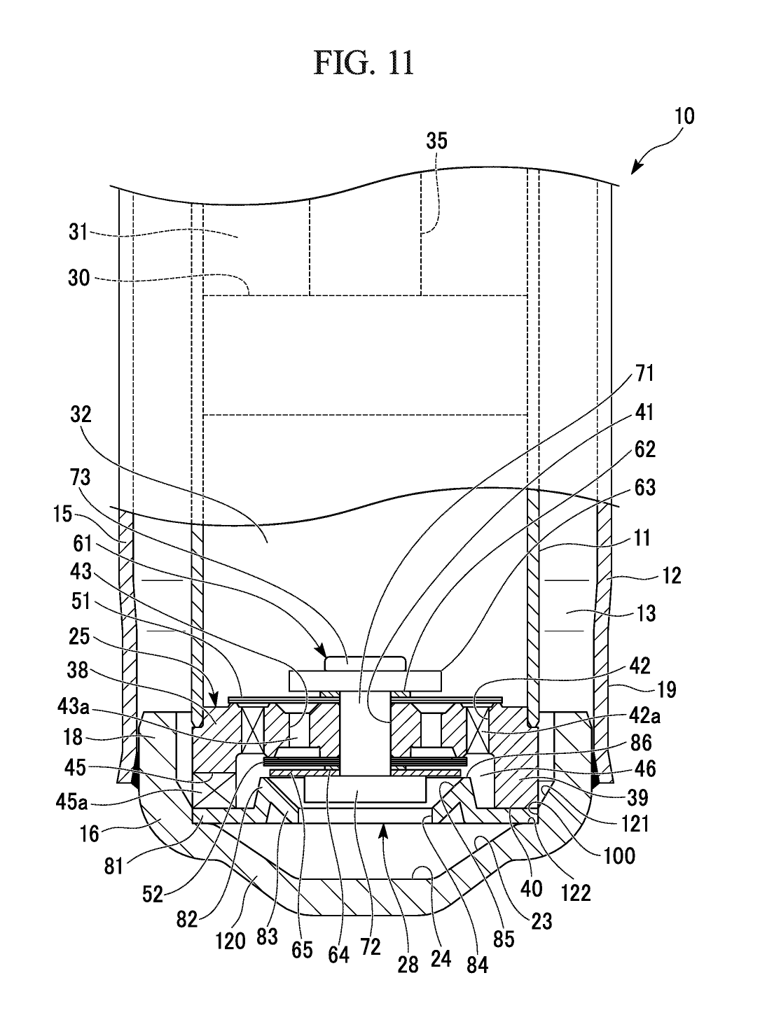

Next, with respect to a second modified example of the first embodiment, portions different from the first embodiment will be mainly described with reference to FIG. 11. In addition, the same designations and the same reference numerals are assigned to the portions common to the first embodiment.

In the second modified example of the first embodiment, a closing portion 120 shown in FIG. 11 is partially different from the closing portion 20 of the first embodiment. In the closing portion 120 of the second modified example, a tubular portion 100 is provided in a portion in a radial direction between an annular flat surface 122 and an outer taper surface 121. Since the outer circumference of the guide member 28 and the outer circumference of the bottom member 25 are held by the tubular portion 100, similarly to the first modified example, it is possible to position the bottom member 25 in the radial direction by the closing portion 120, and it is possible to improve assembly accuracy.

### Third Modified Example of First Embodiment

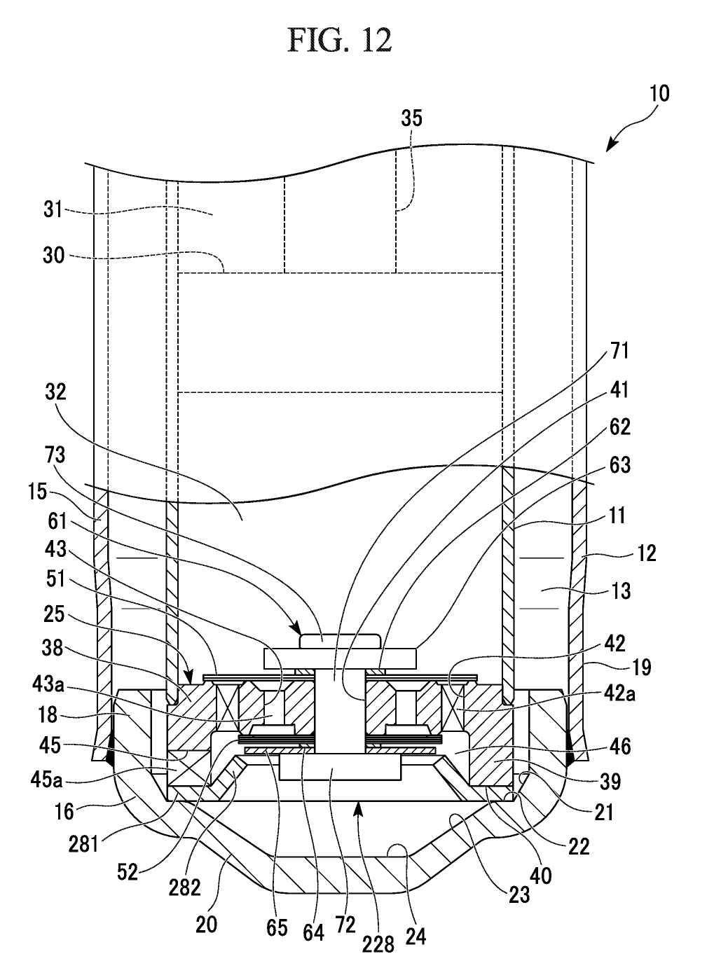

Next, with respect to a third modified example of the first embodiment, portions different from the first embodiment will be mainly described with reference to FIG. 12. In addition, the same designations and the same reference numerals are assigned to the portions common to the first embodiment.

Similarly to the first modified example, in the third modified example of the first embodiment, the inner circumference side of the foot portion 39 of the bottom member 25 is held by an outer taper plate portion 282 of a guide member 228. In addition, in the third medication example, the inner taper plate portion 83 of the first embodiment is not formed. Also in the case of this configuration, similarly to the first and second modified examples, it is possible to hold the inner circumferential side of the foot portion 39 of the bottom member 25 by the outer taper plate portion 282 of the guide member 228, it is possible to perform the positioning in the radial direction, and it is possible to improve assembly accuracy.

The above-described embodiments describe the dual tube type cylinder devices which includes the inner tube in which the working fluid is sealed and the piston provided in the rod slides in the inner portion, and the outer tube which is provided on the outer circumferential side of the inner tube and forms the reservoir chamber in which the working gas and the working fluid are sealed in a portion between the inner tube and the outer tube. The cylinder device includes the bottom member which is provided on the bottom side of the inner tube, and the closing portion which closes the bottom side of the outer tube. The bottom member includes the reservoir chamber side opening which can communicate with the reservoir chamber and the inner portion of the inner tube, the suction passage in which the first valve allowing the working fluid to flow from the reservoir chamber side opening into the inner tube is provided, and the discharge passage in which the second valve allowing the working fluid to flow from the inner portion of the inner tube to the reservoir chamber side opening is provided. The guide member which guides the flow of the working fluid from the reservoir chamber side opening to the suction passage and the flow of the working fluid from the discharge passage to the reservoir chamber side opening is provided between the bottom member and the closing portion. Accordingly, it is possible to smooth the flow of the working fluid without increasing the size of the reservoir chamber side opening.

In addition, since the guide member is formed in a plate shape and is clamped between the bottom member and the closing portion, the attachment structure is simple. Therefore, it is possible to prevent an increase in the cost.

Moreover, since the guide member is attached to the bottom member, it is possible to dispose the guide member in the outer tube along with the bottom member. Accordingly, disposition of the guide member into the outer tube is easy.

### DESCRIPTION OF SYMBOLS

10: cylinder device
11: inner tube
12: outer tube
13: reservoir chamber
20: closing portion
25: bottom member
28, 110: guide member
35: rod
30: piston
45a: reservoir chamber side opening
51: first valve
42a: passage (suction passage)
43a: passage (discharge passage)
52: second valve

1. A dual tube type cylinder device comprising:
an inner tube in which a working fluid is sealed, and a piston provided in a rod slides in the inner portion;
an outer tube which is provided on an outer circumferential side of the inner tube and forms a reservoir chamber in which a working gas and a working fluid are sealed in a portion between the inner tube and the outer tube;
a bottom member which is provided on a bottom side of the inner tube; and
a closing portion which closes a bottom side of the outer tube,
wherein the bottom member includes,
a reservoir chamber side opening which can communicate with the reservoir chamber and the inner portion of the inner tube,
a suction passage in which a first valve allowing the working fluid to flow from the reservoir chamber side opening into the inner tube is provided, and
a discharge passage in which a second valve allowing the working fluid to flow from the inner portion of the inner tube to the reservoir chamber side opening is provided, and
wherein a guide member which guides the flow of the working fluid from the reservoir chamber side opening to the suction passage and the flow of the working fluid from the discharge passage to the reservoir chamber side opening is provided between the bottom member and the closing portion.

2. The cylinder device according to claim 1,
wherein the second valve is configured as an annular disk-shaped valve which is provided on the closing portion side of the bottom member, and in which an outer circumferential side of the valve is bent toward the closing portion side so as to open the valve, and
wherein the guide member has a circular shape, and is clamped by the bottom member and the closing portion.

3. The cylinder device according to claim 1,
wherein the second valve is configured as an annular disk-shaped valve which is provided on the closing portion side of the bottom member, and in which an outer circumferential side of the valve is bent toward the closing portion side so as to open the valve, and
wherein the guide member is attached to the bottom member.

4. The cylinder device according to claim 3,
wherein the second valve and the guide member are coaxially disposed, a shaft member penetrates center axes of the second valve and the guide member, and the second valve and the guide member are attached.

5. The cylinder device according to claim 3,
wherein the guide member is provided to extend toward the closing portion such that an outer circumferential portion of the guide member comes into contact with the closing portion.

6. The cylinder device according to claim 4,
wherein a through hole, which faces a position closer to an inner circumferential side of the second valve relative to the outer circumferential portion of the second valve in an axial direction, is formed in the guide member.

7. The cylinder device according to claim 2,
wherein the guide member is disposed so as to face the outer circumferential portion of the second valve in the axial direction, and regulates deformation of the second valve of a predetermined amount or more when the second valve is open.
